(19) United States
(12) Patent Application Publication
(10) Pub. No.: US 2016/0134578 A1
(43) Pub. Date: May 12, 2016

(54) SYSTEMS AND METHODS FOR IDENTIFYING CONNECTIONS

(71) Applicant: Facebook, Inc., Menlo Park, CA (US)

(72) Inventors: Lexi Beryl Ross, San Francisco, CA (US); Andrew David Prince, Berkeley, CA (US); Margaryta Skrypachova, Redwood City, CA (US); Vladimir Milosevic, San Francisco, CA (US)

(21) Appl. No.: 14/539,154

(22) Filed: Nov. 12, 2014

(51) Int. Cl. H04L 12/58; H04L 29/08

(52) U.S. Cl. CPC H04L 51/32; H04L 67/22; H04L 67/141

(57) ABSTRACT

Various embodiments of the present disclosure can include systems, methods, and non-transitory computer readable media configured to perform a code based technique to identify at least one potential connection for a user. The code based technique comprises generating a code associated with the at least one potential connection; providing the code to a mobile device of the at least one potential connection; and providing information to allow the user to establish a connection with the at least one potential connection.

### FIELD OF THE INVENTION

The present technology relates to the field of communications. More particularly, the present technology relates to techniques for facilitating the identification of friends as connections in a social network.

### BACKGROUND

Today, people utilize computing devices (or systems) for various purposes. Users can use their computing devices to interact with one another, access content, share content, and create content. A user can utilize his or her computing device to interact with a social networking system (or service), such as by providing, viewing, or otherwise accessing information through the social networking system. In some cases, the social networking system can provide an interface or medium for users of the social networking system to communicate with one another.

Two persons may meet and ultimately form a connection on the social networking system in a variety of manners. The two persons may have first become acquainted through online interaction. In this regard, one person may have visited the page of another person; two persons may have become acquainted by email, chat, or instant message; two persons may have been introduced by a common connection; etc. In addition, the two persons may have first become acquainted through offline interaction. In this regard, the persons may have met during any one of the limitless interpersonal opportunities or other social activities that can bring two people together. When two persons meet in an offline context, they can seek to extend their relationship into the online realm. For example, after exchange of identifying information, they in some instances can proceed to find each other's presence on the social networking system based on the identifying information and form a complementary connection there.

### SUMMARY

Various embodiments of the present disclosure can include systems, methods, and non-transitory computer readable media configured to perform a code based technique to identify at least one potential connection for a user. The code based technique comprises generating a code associated with the at least one potential connection; providing the code to a mobile device of the at least one potential connection; and providing information to allow the user to establish a connection with the at least one potential connection.

In an embodiment, it is determined whether position information for a mobile device of the user is available. A position based technique can be performed to identify at least one potential connection for the user after a determination that the position information is available. The position information for the mobile device is based on at least one of GPS, Bluetooth, Wi-Fi (Direct), NFC, and an audio signal.

In an embodiment, the mobile device of the user is at least one of a smartphone, a tablet, a laptop, a wearable device, and a feature phone.

In an embodiment, the performing a position based technique to identify at least one potential connection for the user after a determination that the position information is available further comprises receiving the position information from the mobile device of the user and receiving position information from mobile devices of other users.

In an embodiment, the performing a position based technique to identify at least one potential connection for the user after a determination that the position information is available further comprises receiving time information concerning an indication by the user of an intent to receive connections and receiving time information concerning indications by the other users of their intent to receive connections.

In an embodiment, the performing a position based technique to identify at least one potential connection for the user after a determination that the position information is available further comprises providing a prompt to the user and one of the other users to provide their indications of intent to receive connections at the same time.

In an embodiment, the performing a position based technique to identify at least one potential connection for the user after a determination that the position information is available further comprises determining whether the user and any of the other users are positioned within a predetermined position threshold.

In an embodiment, the performing a position based technique to identify at least one potential connection for the user after a determination that the position information is available further comprises determining whether the indication by the user of an intent to receive connections and any of the indications by the other users of their intent to receive connections occurred within a predetermined time threshold.

In an embodiment, the performing a position based technique to identify at least one potential connection for the user after a determination that the position information is available further comprises identifying the at least one potential connection for the user if the predetermined position threshold and the predetermined time threshold are satisfied with respect to the user and the at least one potential connection.

In an embodiment, the position information is at least one of absolute location and relative position.

In an embodiment, at least one of the predetermined position threshold and the predetermined time threshold is determined by an administrator of a social networking system.

In an embodiment, the performing a position based technique to identify at least one potential connection for the user after a determination that the position information is available further comprises creating a list of the at least one potential connection for the user and sorting the list.

In an embodiment, the performing a position based technique to identify at least one potential connection for the user after a determination that the position information is available further comprises creating a list of at least one potential connection for the user and ranking the list.

In an embodiment, the performing a code based technique to identify at least one potential connection for the user is performed independent of a determination that position information for the mobile device of the user is available.

In an embodiment, the performing a code based technique to identify at least one potential connection for the user further comprises receiving the code from the mobile device of the user and identifying the at least one potential connection for the user based on the code if the code is effective.

In an embodiment, the performing a code based technique to identify at least one potential connection for the user further comprises determining the code is effective if a predetermined effective time duration for the code has not expired.

In an embodiment, the performing a code based technique to identify at least one potential connection for the user further comprises retiring the code for a predetermined retirement duration after expiration of the code and providing the code for reuse after the predetermined retirement duration.

In an embodiment, the performing a code based technique to identify at least one potential connection for a user comprises providing a screen for presentation on the mobile device of the user to allow activation of the code based technique.

Many other features and embodiments of the invention will be apparent from the accompanying drawings and from the following detailed description.

### BRIEF DESCRIPTION OF THE DRAWINGS

FIG. 1 illustrates an example system to allow users to connect with one another in a social networking system, according to an embodiment of the present disclosure.

FIG. 2 illustrates an example position based module configured to determine potential connections for users based on position information, according to an embodiment of the present disclosure.

FIG. 3 illustrates an example code based module configured to produce codes to be provided to mobile devices of users, according to an embodiment of the present disclosure.

FIG. 4 illustrates an example method to identify potential connections utilizing a position based technique or a code based technique, according to an embodiment of the present disclosure.

FIG. 5 illustrates an example method to perform a position based technique to identify potential connections for the user, according to an embodiment of the present disclosure.

FIG. 6 illustrates an example method to perform a code based technique to identify potential connections for the user, according to an embodiment of the present disclosure.

FIG. 7 illustrates an example screen to allow the user to activate a position based technique or a code based technique to establish connections with other users, according to an embodiment of the present disclosure.

FIG. 8 illustrates an example screen to provide information regarding activation of the code based technique, according to an embodiment of the present disclosure.

FIG. 9 illustrates a network diagram of an example system that can be utilized in various scenarios, according to an embodiment of the present disclosure.

FIG. 10 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Identifying Potential Connections for a User

People use social networking systems (or services) for a wide variety of purposes. Users of a social networking system can utilize their computing devices (or systems) to establish connections, communicate, and interact with one another via the social networking system. Users of the social networking system can also create, access, and share various types of content. The social networking system can provide an interface or medium through which news, messages, information, and all types of content are transmitted. A large array of connections in a social network benefits users by providing them with more opportunities to interact with others and their content.

Connections (e.g., friendships) can be formed between entities (e.g., persons, organizations, groups, etc.) in the social networking system by the exchange of identifying information. For instance, a first person can provide her name to a second person and invite the second person to find the first person on the social networking system. Upon finding the first person, the second person can send a friend request to the first person that, if accepted, can establish a connection between them.

This manner by which to form connections on the social networking system has drawbacks. For example, if the exchanged identifying information, such as a name, was not communicated or understood correctly, the ease with which the second person can locate the first person on the social networking system can be compromised. Attributes unique to a particular language may also complicate the ability of the second user to properly enter the name of the first person in a search for the first person on the social networking system. When a social networking system supports a large number of users, the problem is even more pronounced as many potential candidates may be returned as search results in response to an inexact, incorrect, or even exact understanding of the identifying information of the first person. In this situation, it can be difficult to correctly locate the precise person with whom a connection is sought.

In various embodiments, the present disclosure addresses these and other drawbacks associated with conventional techniques. The present disclosure provides techniques for entities to connect without the direct exchange of identifying information that is prone to error. In one position based technique, a user of a computing device can activate position based functionality to prompt a search for potential connections within a social networking system. The technique can include detecting a number of other users who are also utilizing the position based functionality within a predetermined distance threshold from the position of the user and within a predetermined time threshold from the time that the user first utilizes the position based functionality. The user and the detected other users can be presented with an option to establish connections with one another.

In another code based technique, codes may be utilized to allow the user to make connections with other users when the position based functionality of the computing device is not available or not desired. A code can be generated for the user. Further, codes can be generated for the other users. When the user and one of the other users seek to connect, they can provide their codes to one another. In particular, the user can provide her code to the other user or the other user can provide his code to the user, or the user and the other user each can provide their codes to the other. Toward the goal of forming a connection, the user can enter into her computing device the code of the other user. Additionally or alternatively, the other user can enter into his computing device the code of the first user. Upon entry of the code, an option to establish a connection may be provided to each person. In some embodiments, code based technique can be performed without performance or availability of the position based technique. In some embodiments, position based technique can be performed without performance or availability of the code based technique.

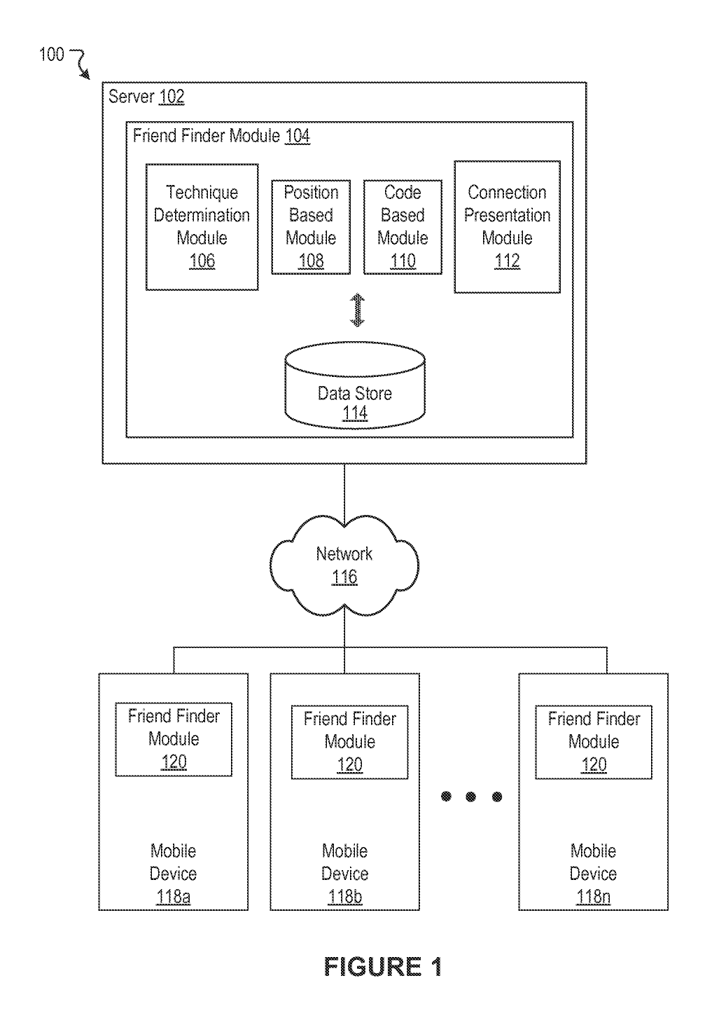

FIG. 1 illustrates an example system 100 including a server 102 in communication with mobile devices 118a-n over a network 116 to allow users associated with the mobile devices 118a-n to connect with one another in a social networking system, according to an embodiment of the present disclosure. The server 102 can include a friend finder module 104 that allows different users of the mobile devices 118a-n to connect with each other. The components of the friend finder module 104 may communicate with a data store 114. The data store 114 can be configured to store and maintain various types of data. In some implementations, the data store 114 can store information associated with a social networking system. The information associated with the social networking system can include data about users, social connections, social interactions, locations, maps, places, events, groups, posts, media, communications, and various other types of data. Some or all of such data may be reflected in a social graph, as described in more detail herein. In some embodiments, the data store 114 can be separate from the friend finder module 104. In some embodiments, the network 116 can be implemented as a network 950 and the each of the mobile devices 118a-n may be implemented as a user device 910, as discussed herein. It is noted the components shown in this figure and all figures herein are exemplary only, and other implementations may include additional, fewer, integrated, or different components. Some components may not be shown so as not to obscure relevant details.

The friend finder module 104 can communicate with the mobile devices 118a-n to allow users of the mobile devices 118a-n to connect in the social networking system without the conventional exchange of user identification information. The friend finder module 104 can support two modes of operation, a position based technique and a code based technique. Each technique may be activated manually by the user or automatically. The friend finder module 104 can include a technique determination module 106, a position based module 108, a code based module 110, and a connection presentation module 112. The technique determination module 106 can receive information from the mobile devices 118a-n to determine if the mobile devices 118a-n can determine or have provided information relating to the position of the mobile devices 118a-n. In some embodiments, when the technique determination module 106 determines that position information has been obtained for a particular mobile device 118 of a user, the technique determination module 106 can provide a screen or other information to the user that allows the user to find potential connections using a position based technique or a code based technique. In some embodiments, if the technique determination module 106 determines that the position information has not been obtained for the mobile device 118 of the user, the technique determination module 106 can provide a screen to the user that allows the user to find potential connections using the code based technique only. In some embodiments, the functionality performed by the technique determination module 106 may be additionally or alternatively performed by the mobile devices 118a-n.

In a position based technique managed by the position based module 108, users of the mobile devices 118a-n can form connections with each other based on different constraints, such as position and time. A friend finder module 120 of the mobile device 118 can obtain position information of the mobile device and time information relating to an indication that the user of the mobile device 118 invites connections with others. As discussed above, in some embodiments, the friend finder module 120 also can implement the functionality of the technique determination module 106. The position information and the time information may be provided by functionality of the mobile device 118. The position information and time information may be provided from the mobile device 118 to the server 102 and the friend finder module 104 in particular. In an embodiment, the friend finder module 104 may determine whether two users are within a predetermined distance threshold from one another and whether the two users have indicated an intent to invite connections with others within a predetermined time threshold of each other's indication of intent. When the predetermined distance threshold and the predetermined time threshold in relation to two or more users are satisfied, the friend finder module 104 can facilitate their identification to one another as potential connections. With respect to a particular user, the friend finder module 104 can determine a set of potential connections in accordance with satisfaction of the predetermined position threshold and the predetermined time threshold and provide the set of potential connections to the mobile device 118 for presentation to the user. After presentation to the user, the user may be invited to form a connection with one or more of the entities in the set of potential connections.

In a code based technique managed by the code based module 110, the friend finder module 104 may generate codes for provision to the mobile devices 118a-n. During a particular time interval, the friend finder module 104 may assign a code to each mobile device 118 of a user. The friend finder module 104 can associate each code with a particular user. The code can be provided from the server 102 to the mobile device 118. In some instances, a screen generated by a friend finder module 120 of the mobile device 118a can present the code to the user of the mobile device 118a. After receipt of a code, the user may use the code as an identifier of herself to allow other potential connections to find the user on the social networking system. If the user wishes to allow a potential connection to find the user on the social networking system to form a connection there, the user may provide her code to the potential connection. The potential connection can be prompted by a friend finder module 120 of the mobile device 118b of the potential connection to enter the code of the user into the mobile device 118b. Upon entry of the code, the code can be provided from the mobile device 118b to the server 102 and the friend finder module 104 in particular. Based on the received code, the friend finder module 104 can cause the page of the user to be presented to the potential connection on the mobile device 118b or otherwise provide an opportunity for the potential connection and the user to establish a connection. Additionally or alternatively, if the potential connection wishes to allow the user to find the potential connection on the social networking system to form a connection there, a process similar to the one described may be utilized. In this regard, the potential connection may provide her code to the user and the user may enter the code of the potential connection on the mobile device 118a of the user.

The connection presentation module 112 can determine the appropriate information to provide to the user of the mobile device 118 after a determination of potential connections for the user. The connection presentation module 112 can provide the identity of one or more potential connections for presentation to the user. In some instances with respect to the position based technique in particular, the connection presentation module 112 can provide a listing of potential connections for presentation to the user, which can be sorted according to categories and ranked according to the likelihood that the user may wish to establish a relationship with each of the potential connections. The connection presentation module 112 can present one or more potential connections to the user by displaying a page associated with each potential connection, such as a profile page or home page of each potential connection. In some instances, the display of such a page can be subject to preexisting privacy settings configured by each potential connection. The page may include a button or link that upon selection can cause a request to establish a connection (e.g., friendship) between the user and each potential connection to be sent to each potential connection. Further, if performance of the position based technique or the code based technique identifies an entity that is a preexisting connection of the user, the connection presentation module 112 accordingly can display information to inform the user that the entity is already a connection. In this instance, the connection presentation module 112 need not display information to allow the user to connect to the preexisting connection.

In some embodiments, the code based technique can be activated automatically when the position based technique is not available or not desired. The position based functionality may not be available when the mobile device of the user does not provide position based functionality or when position based functionality of the mobile device is turned off. In some embodiments, even when the position based technique is available to be used, the user still may opt to use the code based technique. In some embodiments, the code based technique can be activated when the position based technique does not indicate the presence of potential other users with whom to connect.

The illustration of mobile devices 118a-n is exemplary. The mobile devices 118a-n represent any number of mobile devices. The mobile devices 118a-n may be different from one another and have different capabilities. Some of the mobile devices 118a-n may be smart phones, tablets, laptops, wearable devices, or other mobile computing devices having functionality that can provide the position (i.e., actual location or relative position) of the mobile device. Such position functionality of the mobile devices 118a-n can be provided by any one or more of mobile device capabilities, such as GPS, Bluetooth, Wi-Fi (Direct), NFC, and the like. Some of the mobile devices 118a-n may not be smart phones, tablets, laptops, wearable devices, or other mobile computing devices having functionality that can provide the position of the mobile device. Some of the mobile devices 118a-n may be feature phones with no ability to determine the position of the mobile device. Further, some of the mobile phones 118a-n can run a dedicated application on the mobile device that provides the functionality of the present disclosure, a browser that can provide the functionality of the present disclosure, or both. The friend finder module 120 of the mobile device 118 can be implemented as a dedicated mobile application running on the mobile device 118 or as functionality provided by a browser running on the mobile device 118. Further, in some instances, one or more non-mobile devices may be used instead of one or more of the mobile devices 118a-n.

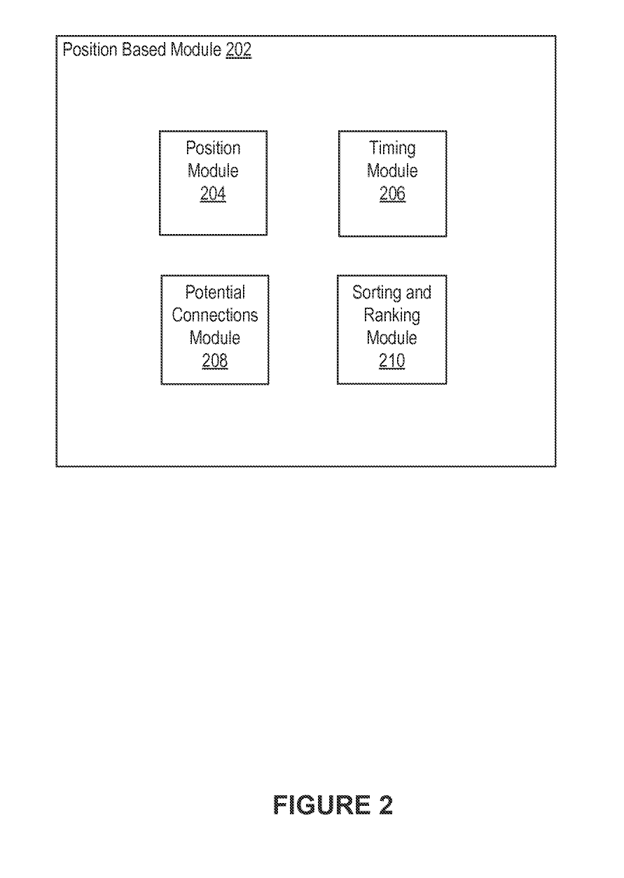

FIG. 2 illustrates an example position based module 202 configured to determine potential connections for users based on position information, according to an embodiment of the present disclosure. In some embodiments, the position based module 108 of FIG. 1 can be implemented as the position based module 202. The position based module 202 can include a position module 204, a timing module 206, a potential connections module 208, and a sorting and ranking module 210.

The position module 204 may receive position information from the mobile devices 118a-n. A position of a mobile device 118, which may include absolute location or relative position, may be determined by any of myriad position functionality provided by the mobile devices 118a-n, such as GPS, Bluetooth, Wi-Fi (Direct), NFC, etc. In some embodiments, sound may be used to determine distance between two mobile devices. In this regard, one mobile device 118a may generate an audio or other high frequency signal. The receipt of the signal by another mobile device 118b can be indicative of the distance between the two mobile devices. Based on the position information provided or determined by the mobile devices 118a-n, the position module 204 may perform an analysis to determine whether any pairs of mobile devices 118a-n are positioned within a predetermined distance threshold from one another. In some embodiments, the analysis also may be determined by the mobile devices 118a-n in whole or in part.

The predetermined distance threshold may be expressed, for example, in any suitable distance measure (e.g., meters, feet, yards, etc.) or longitude/latitude (e.g., thousandth of a degree of longitude). Any suitable value of the predetermined distance threshold can be used (e.g., 10 meters, 50 feet, 300 yards, etc.). While it may provide a relatively smaller number of potential connections for a user, a relatively small distance threshold may provide a relatively higher degree of confidence that a user will wish to establish connections with any identified potential connections for the user. In a similar manner, while it may provide a relatively larger number of potential connections for a user, a relatively large distance threshold may provide a relatively lower degree of confidence that the user will wish to establish connections with any identified potential connections for the user. The position module 204 may determine whether or not the predetermined position threshold is satisfied as between the user and any potential connections.

The timing module 206 may receive time information from the mobile devices 118a-n. The time information may relate to the time the user first indicated an intent to invite the identification of potential connections for the user. In some instances, the user may communicate such indication by appropriate selection of a button or a link of a screen presented to the user on the mobile device 118. For example, a screen presented on the mobile device 118 may invite the user to click on a button to see nearby potential connections with whom the user may wish to establish connections. The time of the indication of the user to invite the identification of potential connections can be provided to the server 102 and the friend finder module 104 in particular. Based on the time information provided by the mobile devices 118a-n, the timing module 206 may perform an analysis to determine whether any indications to invite the identification of potential connections provided to the mobile devices 118a-n occurred within a predetermined time threshold from one another.

The predetermined time threshold may be expressed, for example, in any time measure (e.g., seconds, minutes, etc.). Any suitable value of the predetermined time threshold can be used (e.g., 30 seconds, 1 minute, etc.). While it may provide a relatively smaller number of potential connections for a user, a relatively small time threshold may provide a relatively higher degree of confidence that a user will wish to establish connections with any identified potential connections for the user. In a similar manner, while it may provide a relatively larger number of potential connections for a user, a relatively large time threshold may provide a relatively lower degree of confidence that the user will wish to establish connections with any identified potential connections for the user. The timing module 206 may determine whether or not the predetermined timing threshold is satisfied as between the user and any potential connections.

The potential connections module 208 can identify potential connections for the user after the predetermined position threshold and the predetermined time threshold are both satisfied. The satisfaction of the predetermined position threshold and the predetermined time threshold can represent a desire (or declaration of intent) of two users to connect with one another. The potential connections module 208 can identify as potential connections one or more users associated with the mobile devices 118a-n that have satisfied the applicable constraints (e.g., position and time) for identification of potential connections for the user. In some instances, when the applicable constraints are not satisfied, the potential connections module 208 may not identify any potential connections. In some embodiments, when no potential connections are identified using the position based technique, the user may opt to identify potential connections using the code based technique as described in more detail herein.

The potential connections module 208 may identify entities that already are connections of the user. Upon satisfaction of the applicable constraints, the potential connections module 208 may distinguish potential connections from preexisting connections of the user. The potential connections and the preexisting connections can be identified or labeled as such. Because the user does not need to establish a connection with a preexisting connection, there is no need to provide an invitation to the user or the preexisting connection to form a connection between them. Rather, the potential connections module 208 may provide to the connection presentation module 112 information relating to the identity of each preexisting connection and her status as a preexisting connection of the user for display to the user.

The sorting and ranking 210 may sort and rank any potential connections identified by the potential connections module 208. The sorting and ranking 210 may sort the potential candidates based on one or more categories, such as friends, family, classmate, work colleagues, gender, interests, age, etc.

In addition, the sorting and ranking 210 may rank the potential connections based on various criteria. Such criteria can include, for example, position proximity, time proximity, or any other constraint considered and applied in the original identification of potential connections for the user. Such criteria also can include graph proximity between the user and each potential connection or other quantitative or qualitative assessments of affinity between the user and each potential connection. For example, if the user and a first potential connection share a high value of (indirect) connection (or are separated by fewer degrees of separation) and the user and a second potential connection share a lower value of (indirect) connection (or are separated more degrees of separation), then the sorting and ranking 210 may rank the first potential connection higher than the second potential connection. The sorting and ranking of the potential connections can be provided to the connection presentation module 112 for sorted and ranked display of the potential connections to the user.

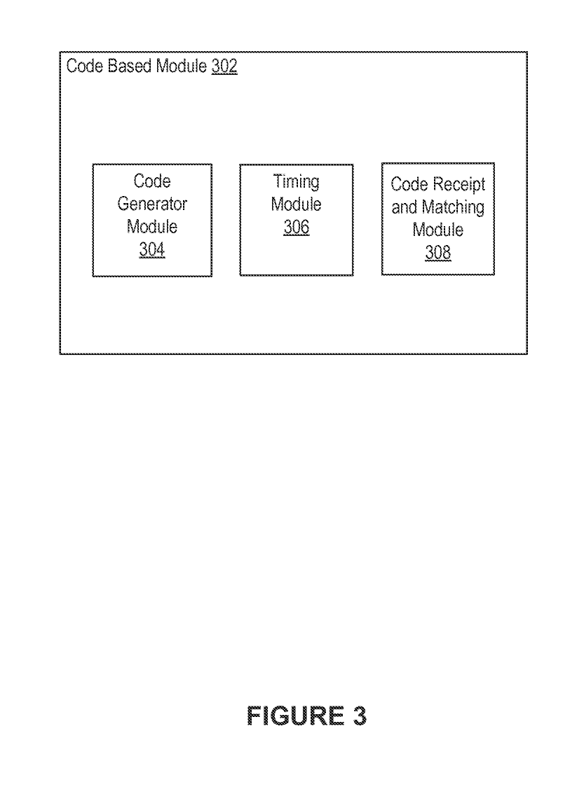

FIG. 3 illustrates an example code based module 302 configured to produce codes to be provided to mobile devices of users, according to an embodiment of the present disclosure. In some embodiments, the code based module 110 of FIG. 1 can be implemented as the code based module 302. The code based module 302 can include a code generator module 304, a timing module 306, and a code receipt and matching module 308.

The code generator module 304 can generate a code for provision to the mobile device 118. The code can be of any suitable type, value, and length. In some instances, the type of the code can be numeric, alphanumeric, or of any format readily provided by a user to the mobile device 118. In some instances, the value of the code can be generated randomly, pseudo randomly, or in a planned manner designed by the code based module 302. In some instances, the length of the code can be predetermined (e.g., five digits, seven characters, etc.). In this regard, a relatively shorter code may be simpler for users to remember and enter. On the other hand, a relatively shorter code may be simpler to steal and harder to accommodate a larger number of users without reuse of the code. In a similar manner, a relatively longer code may be harder for users to remember and enter. On the other hand, a relatively longer code may be harder to steal and simpler to accommodate a larger number of users.

The timing module 306 can assign to each generated code a predetermined effective time duration during which the code is effective and after which the code is not effective. The assignment of a predetermined effective time duration to each code can allow the friend finder module 104 to more easily reuse codes when the number of users in the social networking system is large. The predetermined effective time duration can be any suitable value (e.g., 60 seconds, 15 minutes, one hour, etc.).

The timing module 306 also can retire the code after the predetermined effective time duration for a predetermined retirement duration so that the code is not accidentally reused. After passage of the predetermined retirement duration for a particular code, the timing module 306 can communicate the availability of the code to the code generator module 304. The code generator module 304, in turn, can make the code available for assignment again.

When a generated code is entered by the user of the mobile device 118, the code is provided to the server 102 and the friend finder module 104 in particular. The code receipt and matching module 308 can receive the code and determine if the code is effective during the predetermined effective time duration. If the code is effective, the code is matched to its corresponding mobile device and associated potential connection. The identity of the potential connection associated with the code can be provided to the connection presentation module 112 so that the user can be presented with an opportunity to establish a connection with the potential connection. If the code is not effective because the predetermined effective time duration of the code has expired or because the code is in retirement, the code is not matched to any mobile device. If an ineffective code is entered by a user, the connection presentation module 112 can return an error message, such as a message to the user that the code is expired and thus cannot be used to help establish a connection with another user.

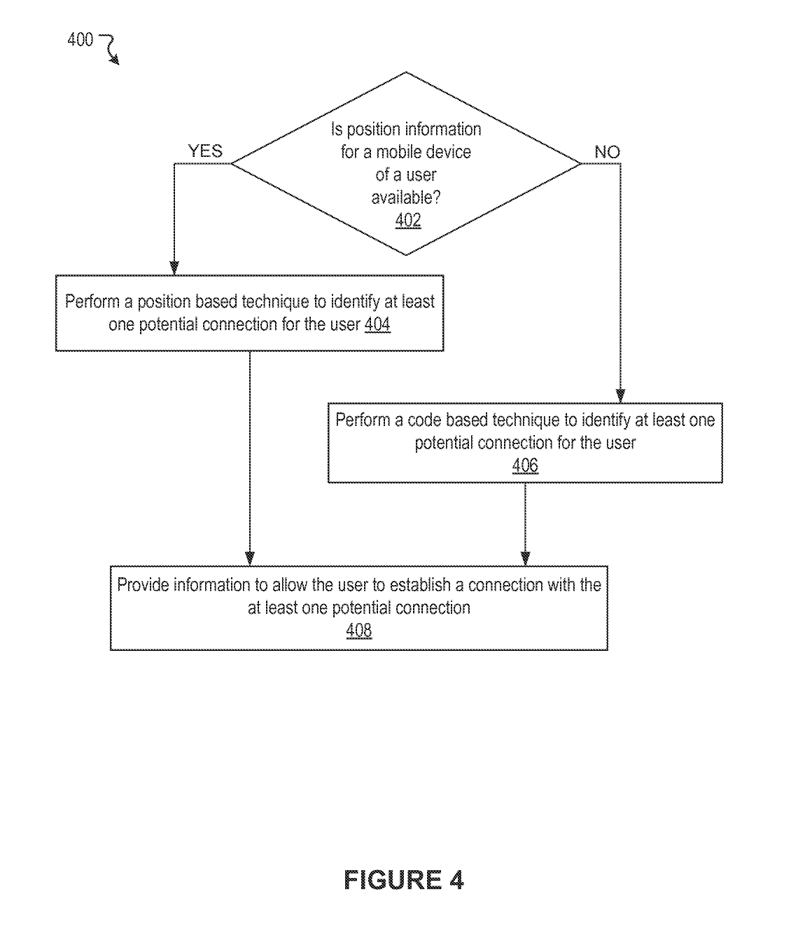

FIG. 4 illustrates an example method 400 to identify potential connections utilizing a position based technique or a code based technique, according to an embodiment of the present disclosure. It should be appreciated that there can be additional, fewer, or alternative steps performed in similar or alternative orders, or in parallel, within the scope of the various embodiments unless otherwise stated. In some embodiments, the steps of this method and all illustrated methods herein can be performed by the modules depicted in other figures of the present disclosure, as described in more detailed herein.

At block 402, the method 400 can determine whether position information for a mobile device of a user is available. If the result of block 402 is yes, the method 400 proceeds to block 404. At block 404, the method 400 can perform a position based technique to identify at least one potential connection for the user. If the result of block 402 is no, the method 400 proceeds to block 406. At block 406, the method 400 can perform a code based technique to identify at least one potential connection for the user. The method 400 proceeds from block 404 and block 406 to block 408. At block 408, the method 400 can provide information to allow the user to establish a connection with the at least one potential connection.

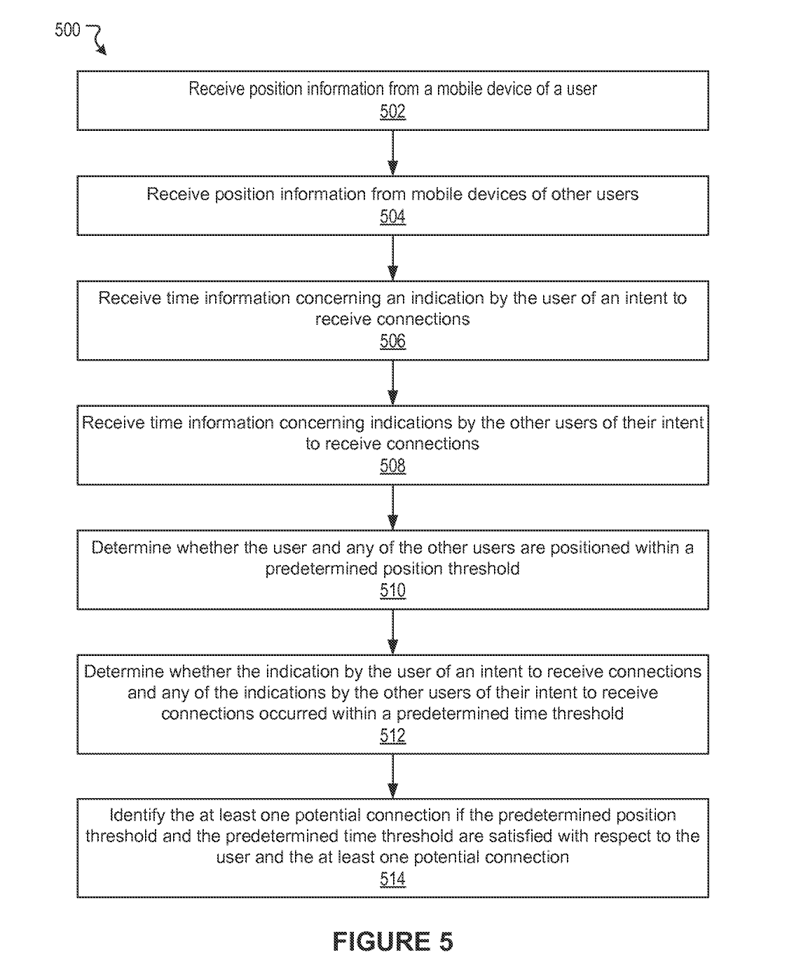

FIG. 5 illustrates an example method 500 to perform a position based technique to identify potential connections for the user, according to an embodiment of the present disclosure. It should be appreciated that there can be additional, fewer, or alternative steps performed in similar or alternative orders, or in parallel, within the scope of the various embodiments unless otherwise stated.

At block 502, the method 500 can receive position information from a mobile device of a user. At block 504, the method 500 can receive position information from mobile devices of other users. At block 506, the method 500 can receive time information concerning an indication by the user of an intent to receive connections. At block 508, the method 500 can receive time information concerning indications by the other users of their intent to receive connections. At block 510, the method 500 can determine whether the user and any of the other users are positioned within a predetermined position threshold. At block 512, the method 500 can determine whether the indication by the user of an intent to receive connections and any of the indications by the other users of their intent to receive connections occurred within a predetermined time threshold. At block 514, the method 500 can identify the at least one potential connection if the predetermined position threshold and the predetermined time threshold are satisfied with respect to the user and the at least one potential connection.

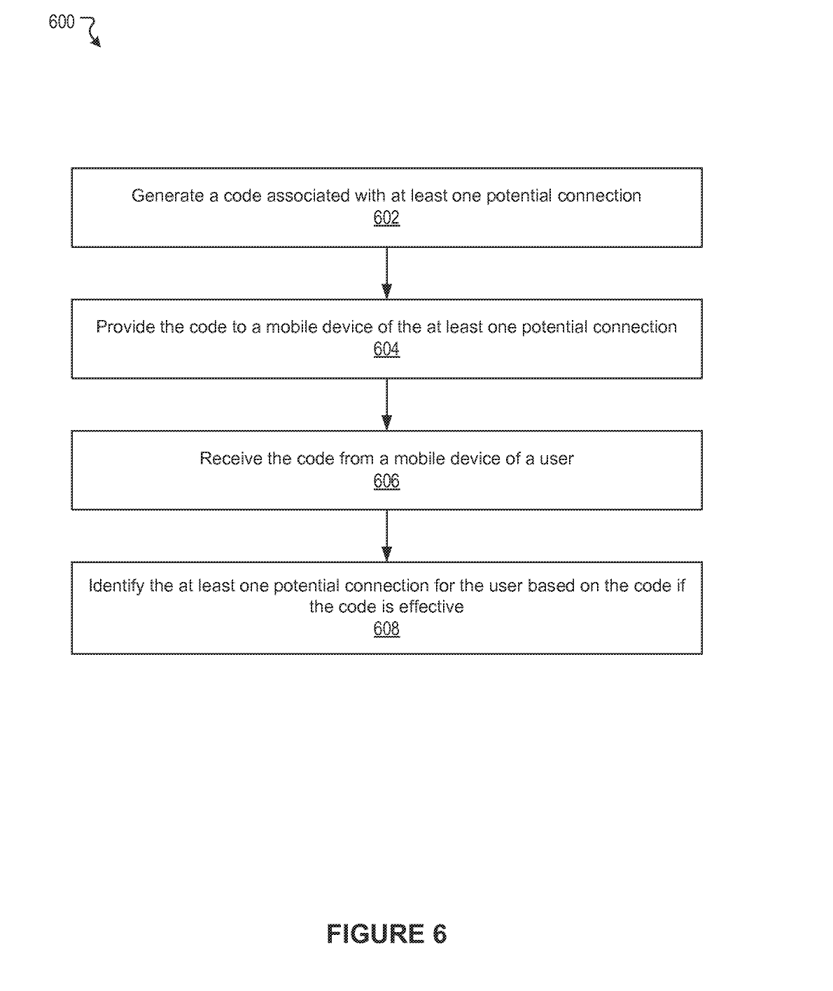

FIG. 6 illustrates an example method 600 to perform a code based technique to identify potential connections for the user, according to an embodiment of the present disclosure. It should be appreciated that there can be additional, fewer, or alternative steps performed in similar or alternative orders, or in parallel, within the scope of the various embodiments unless otherwise stated.

At block 602, the method 600 can generate a code associated with at least one potential connection. At block 604, the method 600 can provide the code to a mobile device of the at least one potential connection. At block 606, the method 600 can receive the code from a mobile device of a user. At block 608, the method 600 can identify the at least one potential connection for the user based on the code if the code is effective.

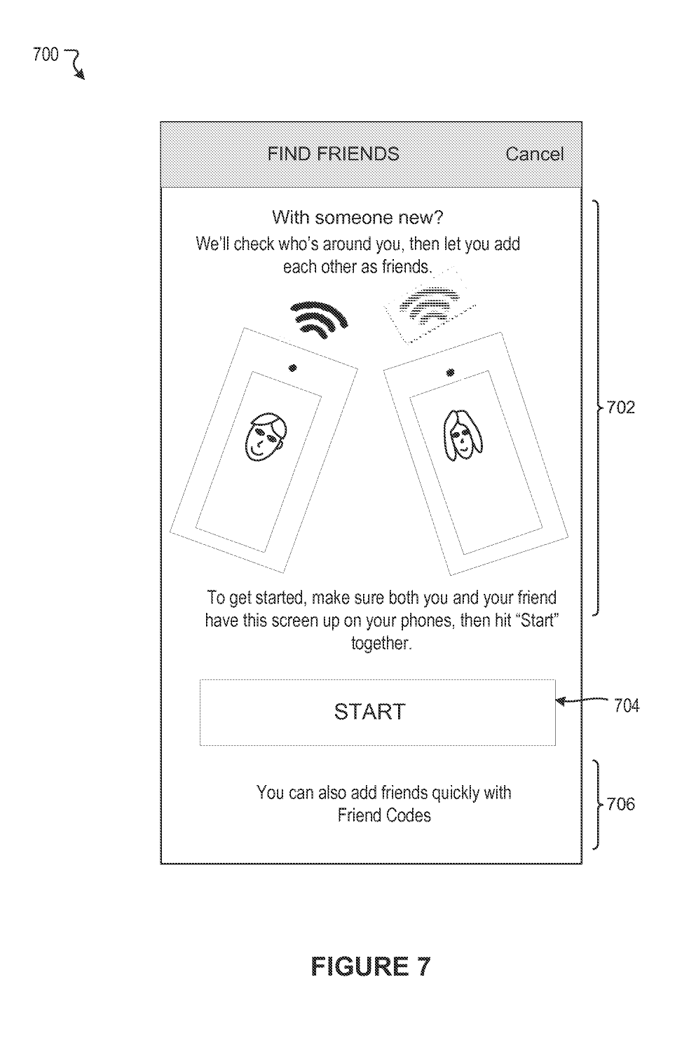

FIG. 7 illustrates an example screen 700 relating to a position based technique or a code based technique to establish connections with other users, according to an embodiment of the present disclosure. An explanation section 702 of the screen 700 can display information and directions about how to activate the position based technique. The explanation section 702 can state that the user of the mobile device presenting the screen 700 can utilize the position based technique to find nearby potential connections. The explanation section 702 also can describe for the user the proper manner of activating the position based technique. A button 704, when depressed by the user, causes activation of the position based technique. A link section 706, when depressed, can lead to another screen to activate the code based technique to identify potential connections.

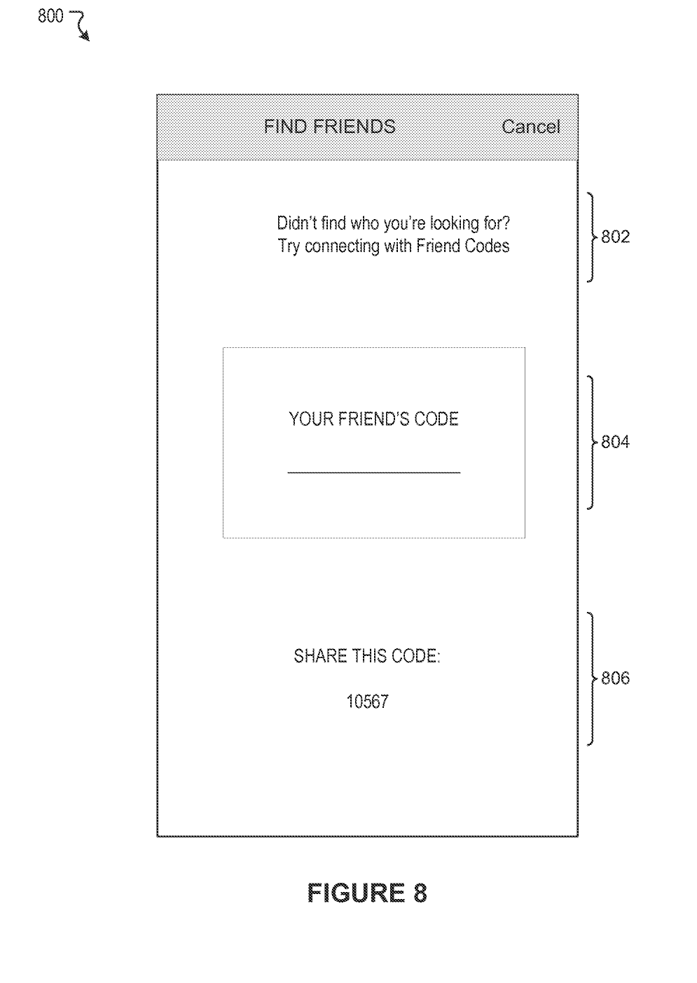

FIG. 8 illustrates an example screen 800 relating to a code based technique, according to an embodiment of the present disclosure. An explanation section 802 of the screen 800 can encourage use of the code based technique of the screen 800. A friend code section 804 can provide to the user of the mobile device an interface by which to enter the code of a potential connection. A user code section 806 can display to the user a code generated for and associated with the user. The code associated with the user can be shared with others so that the others can utilize the code to establish connections with the user. The illustrated screens are exemplary and other screens allowing the user to activate the position based technique and the code based technique may differ in design.

### Social Networking System—Example Implementation

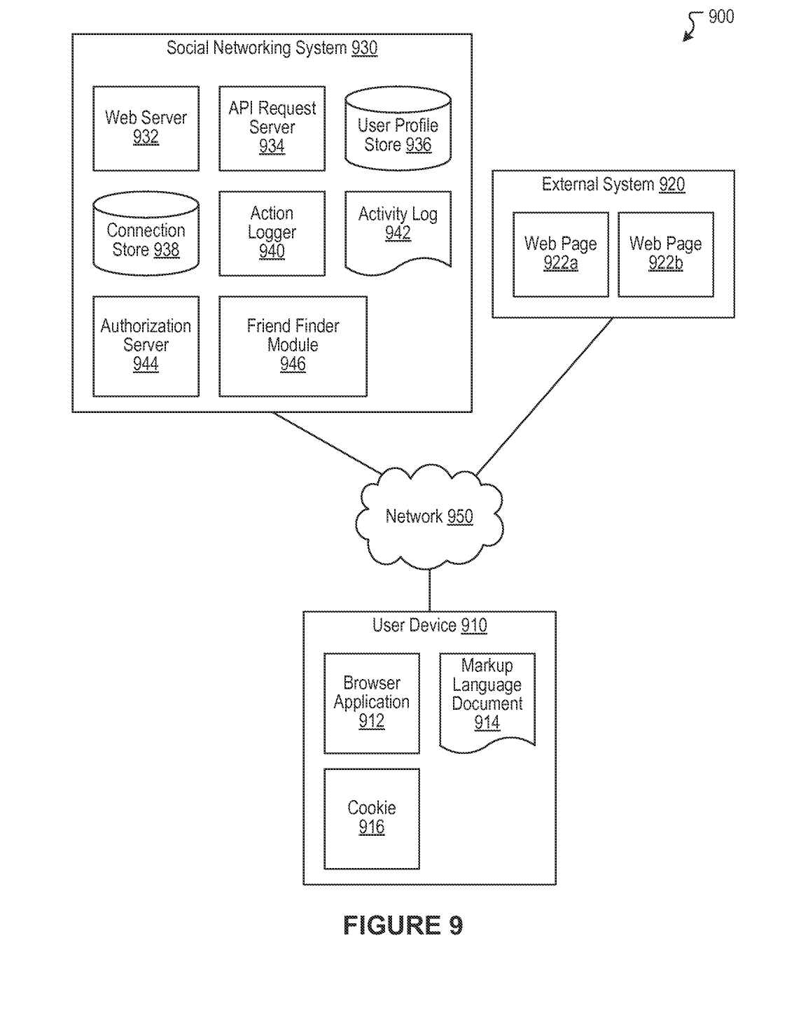

FIG. 9 illustrates a network diagram of an example system 900 that can be utilized in various scenarios, in accordance with an embodiment of the present disclosure. The system 900 includes one or more user devices 910, one or more external systems 920, a social networking system (or service) 930, and a network 950. In an embodiment, the social networking service, provider, and/or system discussed in connection with the embodiments described above may be implemented as the social networking system 930. For purposes of illustration, the embodiment of the system 900, shown by FIG. 9, includes a single external system 920 and a single user device 910. However, in other embodiments, the system 900 may include more user devices 910 and/or more external systems 920. In certain embodiments, the social networking system 930 is operated by a social network provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 910 comprises one or more computing devices that can receive input from a user and transmit and receive data via the network 950. In one embodiment, the user device 910 is a conventional computer system executing, for example, a Microsoft Windows compatible operating system (OS), Apple OS X, and/or a Linux distribution. In another embodiment, the user device 910 can be a device having computer functionality, such as a smart-phone, a tablet, a personal digital assistant (PDA), a mobile telephone, etc. The user device 910 is configured to communicate via the network 950. The user device 910 can execute an application, for example, a browser application that allows a user of the user device 910 to interact with the social networking system 930. In another embodiment, the user device 910 interacts with the social networking system 930 through an application programming interface (API) provided by the native operating system of the user device 910, such as iOS and ANDROID. The user device 910 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 910 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 910. The browser application 912 on the user device 910 may use a JavaScript compiler to decode the markup language document 914.

The markup language document 914 may also include, or link to, applications or application frameworks such as FLASH™ or Unity™ applications, the SilverLight™ application framework, etc.

In one embodiment, the user device 910 also includes one or more cookies 916 including data indicating whether a user of the user device 910 is logged into the social networking system 930, which may enable modification of the data communicated from the social networking system 930 to the user device 910.

The external system 920 includes one or more web servers that include one or more web pages 922a, 922b, which are communicated to the user device 910 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content.

The social networking system 930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 910. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, and an authorization server 944. In an embodiment of the invention, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment of the invention, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 910 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 910. The messages can be instant messages, queued messages (e.g., email), text and SMS messages, or any other suitable messaging format.

The API request server 934 allows one or more external systems 920 and user devices 910 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 920. In another embodiment, the user device 910 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

In some embodiments, the social networking system 930 can include a friend finder module 946. The friend finder module 946 can, for example, be implemented as the friend finder module 104 of FIG. 1. The friend finder module 946 can provide techniques for entities to connect without the direct exchange of identifying information that is prone to error. In one position based technique, a user of a computing device can activate position based functionality to prompt a search for potential connections within a social networking system. The technique can include detecting a number of other users who are also utilizing the position based functionality within a predetermined distance threshold from the position of the user and within a predetermined time threshold from the time that the user first utilizes the position based functionality. The user and the detected other users can be presented with an option to establish connections with one another. In another code based technique, codes may be utilized to allow the user to make connections with other users when the position based functionality of the computing device is not available or not desired. A code can be generated for the user. Further, codes can be generated for the other users. When the user and one of the other users seek to connect, they can provide their codes to one another. Upon entry of the code, an option to establish a connection may be provided to each person. Other features of the friend finder module 946 are discussed herein in connection with the friend finder module 104.

### Hardware Implementation

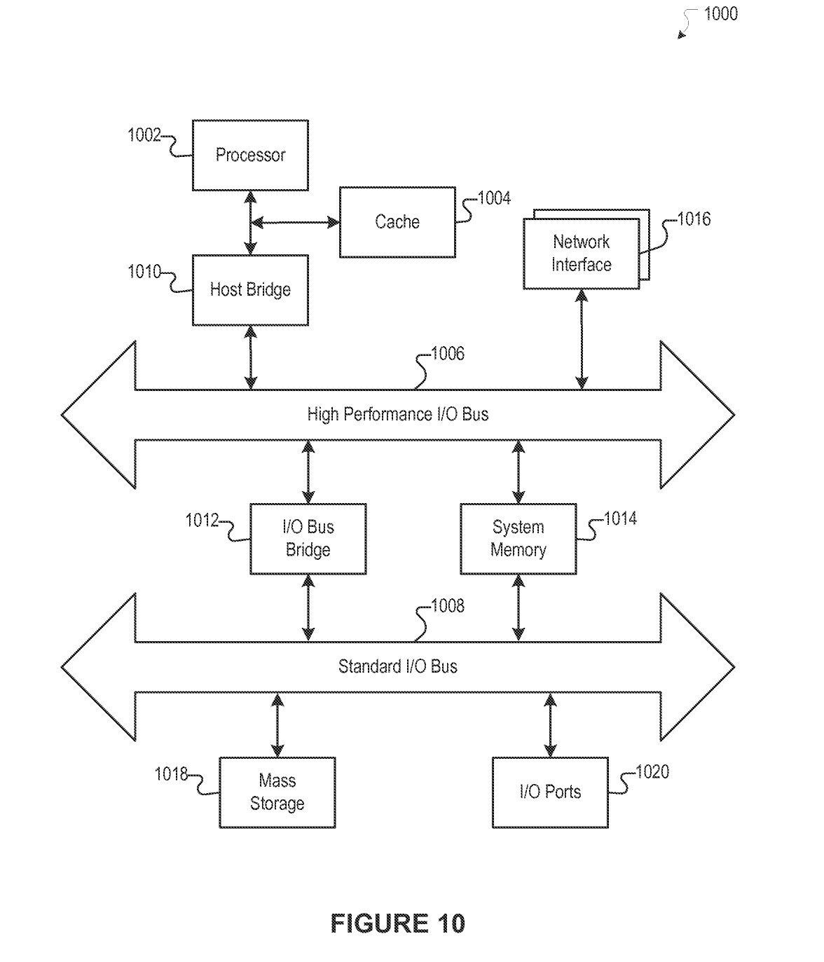

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment of the invention, the computer system 1000 may be the social networking system 930, the user device 910, and the external system 920, or a component thereof. In an embodiment of the invention, the computer system 1000 may be one server among many that constitutes all or part of the social networking system 930.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Moreover, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
performing, by a computing system, a code based technique to identify at least one potential connection for a user, comprising:
generating, by the computing system, a code associated with the at least one potential connection;
providing, by the computing system, the code to a mobile device of the at least one potential connection; and
providing, by the computing system, information to allow the user to establish a connection with the at least one potential connection.

2. The computer-implemented method of claim 1, further comprising:
determining whether position information for a mobile device of the user is available; and
performing a position based technique to identify at least one potential connection for the user after a determination that the position information is available, wherein the position information for the mobile device of the user is based on at least one of GPS, Bluetooth, Wi-Fi (Direct), NFC, and an audio signal.

3. The computer-implemented method of claim 2, wherein the mobile device of the user is at least one of a smartphone, a tablet, a laptop, a wearable device, and a feature phone.

4. The computer-implemented method of claim 2, wherein the performing a position based technique to identify at least one potential connection for the user after a determination that the position information is available further comprises:
receiving the position information from the mobile device of the user; and
receiving position information from mobile devices of other users.

5. The computer-implemented method of claim 4, wherein the performing a position based technique to identify at least one potential connection for the user after a determination that the position information is available further comprises:
receiving time information concerning an indication by the user of an intent to receive connections; and
receiving time information concerning indications by the other users of their intent to receive connections.

6. The computer-implemented method of claim 5, wherein the performing a position based technique to identify at least one potential connection for the user after a determination that the position information is available further comprises:
providing a prompt to the user and one of the other users to provide their indications of intent to receive connections at the same time.

7. The computer-implemented method of claim 5, wherein the performing a position based technique to identify at least one potential connection for the user after a determination that the position information is available further comprises:
determining whether the user and any of the other users are positioned within a predetermined position threshold.

8. The computer-implemented method of claim 7, wherein the performing a position based technique to identify at least one potential connection for the user after a determination that the position information is available further comprises:
determining whether the indication by the user of an intent to receive connections and any of the indications by the other users of their intent to receive connections occurred within a predetermined time threshold.

9. The computer-implemented method of claim 8, wherein the performing a position based technique to identify at least one potential connection for the user after a determination that the position information is available further comprises:
identifying the at least one potential connection for the user if the predetermined position threshold and the predetermined time threshold are satisfied with respect to the user and the at least one potential connection.

10. The computer-implemented method of claim 9, wherein the position information is at least one of absolute location and relative position.

11. The computer-implemented method of claim 9, wherein at least one of the predetermined position threshold and the predetermined time threshold is determined by an administrator of a social networking system.

12. The computer-implemented method of claim 9, wherein the performing a position based technique to identify at least one potential connection for the user after a determination that the position information is available further comprises:
creating a list of the at least one potential connection for the user; and
sorting the list.

13. The computer-implemented method of claim 9, wherein the performing a position based technique to identify at least one potential connection for the user after a determination that the position information is available further comprises:
creating a list of the at least one potential connection for the user; and
ranking the list.

14. The computer-implemented method of claim 1, wherein the performing a code based technique to identify at least one potential connection for the user is performed independent of a determination that position information for the mobile device of the user is available.

15. The computer-implemented method of claim 14, wherein the performing a code based technique to identify at least one potential connection for the user further comprises:
receiving the code from the mobile device of the user; and
identifying the at least one potential connection for the user based on the code if the code is effective.

16. The computer-implemented method of claim 15, wherein the performing a code based technique to identify at least one potential connection for the user further comprises:
determining the code is effective if a predetermined effective time duration for the code has not expired.

17. The computer-implemented method of claim 16, wherein the performing a code based technique to identify at least one potential connection for the user further comprises:
retiring the code for a predetermined retirement duration after expiration of the code; and
providing the code for reuse after the predetermined retirement duration.

18. The computer-implemented method of claim 1, wherein the performing a code based technique to identify at least one potential connection for a user further comprises:
providing a screen for presentation on the mobile device of the user to allow activation of the code based technique.

19. A system comprising:
at least one processor; and
a memory storing instructions that, when executed by the at least one processor, cause the system to perform:
performing a code based technique to identify at least one potential connection for a user, comprising;
generating a code associated with the at least one potential connection;
providing the code to a mobile device of the at least one potential connection; and
providing information to allow the user to establish a connection with the at least one potential connection.

20. A non-transitory computer-readable storage medium including instructions that, when executed by at least one processor of a computing system, cause the computing system to perform:
performing a code based technique to identify at least one potential connection for a user, comprising:
generating a code associated with the at least one potential connection;
providing the code to a mobile device of the at least one potential connection; and
providing information to allow the user to establish a connection with the at least one potential connection.
